(19) United States
(12) Patent Application Publication
(10) Pub. No.: US 2009/0313388 A1
(43) Pub. Date: Dec. 17, 2009

(54) Wireless communication networks based on existing digital broadcasting protocols

(76) Inventor: Pen Chung Li, San Jose, CA (US)

Correspondence Address: Pen C. Li, 1109 Littleoak Circle, San Jose, CA, 95129, US

(21) Appl. No.: 12/138,422

(22) Filed: Jun. 13, 2008

(51) Int. Cl. G06F 15/16

(52) U.S. Cl. 709/248

(57) ABSTRACT

A system, apparatus and method are described for transforming an existing broadcasting protocol to a wireless communication networks. Since the initial frequency band is unknown between the server and the client, a protocol is proposed to synchronize the client with the server first in frequency band and second in time. Once the synchronization is done, any message exchanging protocols can facilitate communications. For example, several packets in the broadcasting protocols can be aggregated to form a frame structure. The same protocol can be used when there is a repeater between the server and the client. For video application, a rendering device such as a TV could be controlled by the client via an interface such as infrared. The rendering device can be automatically tuned to the server's transmit frequency automatically by the client without user's intervention.

### FIELD OF THE INVENTION

The present invention relates generally to systems, methods and apparatuses for establishing a wireless communication network using an existing broadcasting protocol.

### BACKGROUND

The proliferation of wireless devices has generated great demands for the frequency spectrums. The cost of frequency spectrum has skyrocketed since twenty years ago when spectrums could be obtained freely by simply filling an application with FCC. A recent auction of 22 MHz bandwidth at 700 MHz band cost the bidder more than $4.7 B.

However, the deceptively crowded spectrum has very low utilization. One study shows that urban areas use less than 6.5% of the spectrums when averaged in time and location. Averaged over time at one location, 77.6% of spectrum is actually vacant, meaning as much as 5.3 GHz bandwidth is available for usages beyond what were originally specified as primary applications.

One of the spectrums under discussion is the analog TV spectrum which is to be released after the inception of digital TV. To avoid interference, as illustrated in FIG. 1, TV spectrums have been used in an interleaved way; adjacent TV stations use different frequency spectrums from each other.

The concept of cognitive radio has been proposed to take advantage of these vacant spectrums by overlaying another wireless network on the existing Wireless Primary Network's (WPN). This overlaid network is called Wireless Overlay Network (WON). The intended transmitter of the WON's device would detect and avoid (DAA) the WPN spectrum so that none of the transmissions will affect the primary users.

Once the spectrum becomes available, a new communication protocol is needed to take advantage of these spectrums. However, the standardization process typically takes two to three years to finish, which means it will take at least four to five years for products to reach mass market. It is thus worth noting that the existing TV bands are mandated to use a digital broadcasting protocol such as ATSC in the U.S and DVB-T in Europe. If a simple revision can be amended to enable a communication network that can have the function of client-server topology similar to Wi-Fi, the market adoption rate can be dramatically accelerated.

What is needed is systems, methods and apparatuses that can establish a wireless communication network using an existing broadcasting protocol.

### SUMMARY

A system, apparatus and method are described for transforming an existing broadcasting protocol to a wireless communication networks. Since the initial frequency band is unknown between the server and the client, a protocol is proposed to synchronize the client with the server first in frequency band and second in time. Once the synchronization is done, any message exchanging protocols can facilitate communications. For example, several packets in the broadcasting protocols can be aggregated to form a frame structure. The same protocol can be used when there is a repeater between the server and the client. For video application, a rendering device such as a TV could be controlled by the client via an interface such as infrared. The rendering device can be automatically tuned to the server's transmit frequency automatically by the client without user's intervention.

### BRIEF DESCRIPTION OF THE DRAWINGS

The invention may be more completely understood in consideration of the following detailed description of various embodiments of the invention in connection with the accompanying drawings, in which:

FIG. 1 shows a client-server network consists of a server and a client, which communicates each other via an existing broadcasting protocol;

FIG. 2 shows one embodiment of the server's synchronization protocol;

FIG. 3 shows one embodiment of the client's synchronization protocol;

FIG. 4 shows one embodiment of the network with a repeater;

FIG. 5 shows a client-server network transmitting video to a TV, which is connected to the client.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined by the appended claims.

### DETAILED DESCRIPTION

A system, apparatus and method are described for establishing a wireless communication system based on an existing broadcasting protocol. It is assumed that neither station in the system has a priori information about the frequency bands they can use. The frequency band can only be used if certain detect and avoid (DAA) mechanisms are used to determine the vacant frequency bands.

The same methods can be used to establish client-server networks or peer-to-peer networks. To reduce adjacent channel interference, power control schemes can be deployed on this system. Repeaters can be added to extend the coverage. When used in video distribution application, the client station next to the TV can change the TV channel seamlessly without user intervention according to the transmit frequency from the server station. If multiple frequency bands need to be cleared so that the transmitter can meet the regulatory requirements, another protocol can be amended to facilitate it. Similarly, additional encryption schemes can be added for protecting Digital Rights Management (DRM).

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. Structures and devices shown below in the block diagram are illustrative of exemplary embodiments of the invention and are meant to avoid obscuring the invention. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phase “in one embodiment” in various places in the specification are not necessarily all referring to the same embodiment.

1. Wireless Client-Server Network

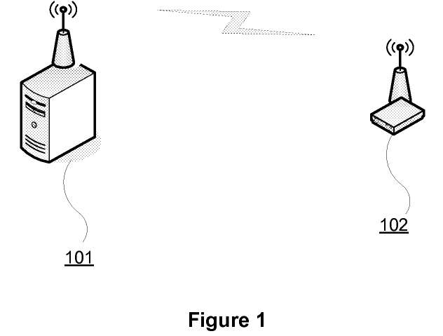

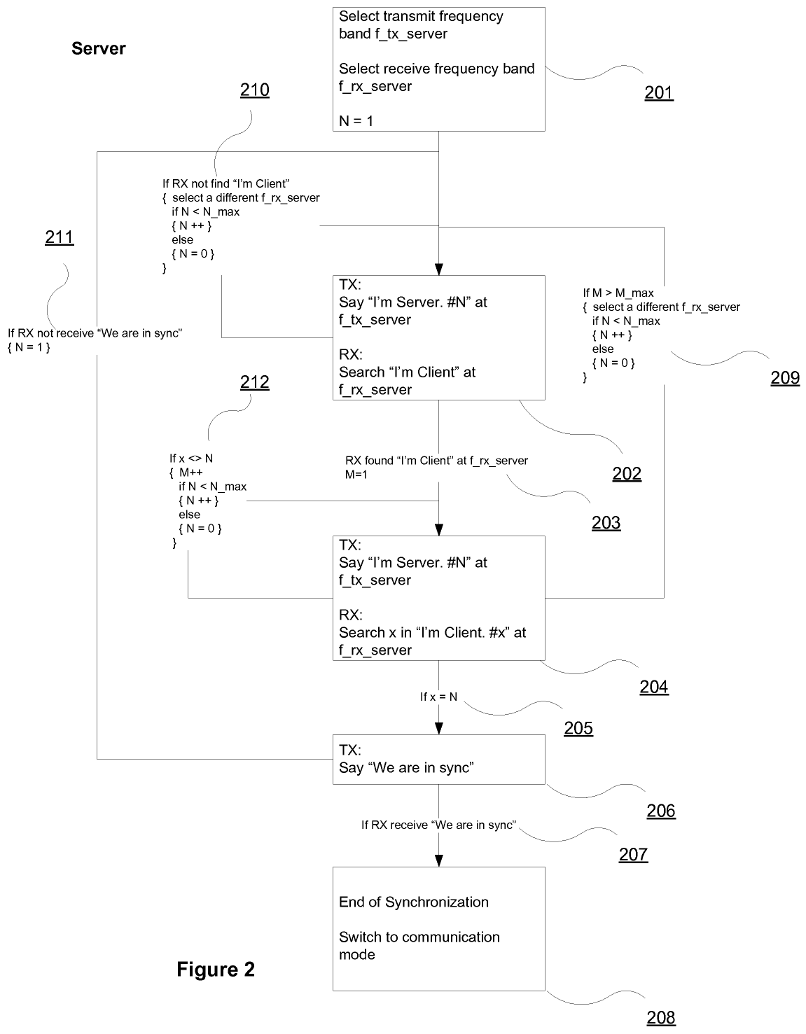

FIG. 1 shows a wireless client-server network that establishes the link between the server 101 and the client 102. FIG. 2 shows the flow chart on how the server 101 establishes the link. At step 201, a DAA mechanism selects a transmit frequency f_tx_server, and an arbitrary f_rx_server is selected. N is a running index, showing the sequence number of the current packet. Since all the digital broadcasting protocols have frame structures, a packet is consisted of multiple frames.

In one embodiment, at step 202, certain binary data string representing the message “I'm Server. #N” is transmitted at frequency f_tx_server. In the mean time, the receiver is searching for another binary data string representing the message “I'm Client” at frequency f_rx_server.

If the receiver cannot find “I'm Client” at frequency f_rx_server at the condition 210, a different receive frequency f_rx_server is selected. Also, if N is less than N_max. N is incremented by one; otherwise, N is reset to zero. Step 202 is then repeated.

When the receiver find “I'm Client” at condition 203, M is set to 1, indicating the first try to synchronize N from the client at step 204. Note that now f_rx_server is the same as f_tx_client, which is called the uplink frequency.

After M_max tries, if the receiver still cannot synchronize x with N as shown in condition 209, the protocol moves back to step 202. However, if x is found to be the same as N as shown in condition 205, TX transmits the binary data string representing the message “We are in sync” at step 206.

The receiver is supposed to receive in the next packet “We are in sync” as shown in condition 207, and move to step 208. Otherwise, the protocol moves back to step 202 as shown in condition 211.

Step 208 represents the end of synchronization. The protocol moves to communication mode.

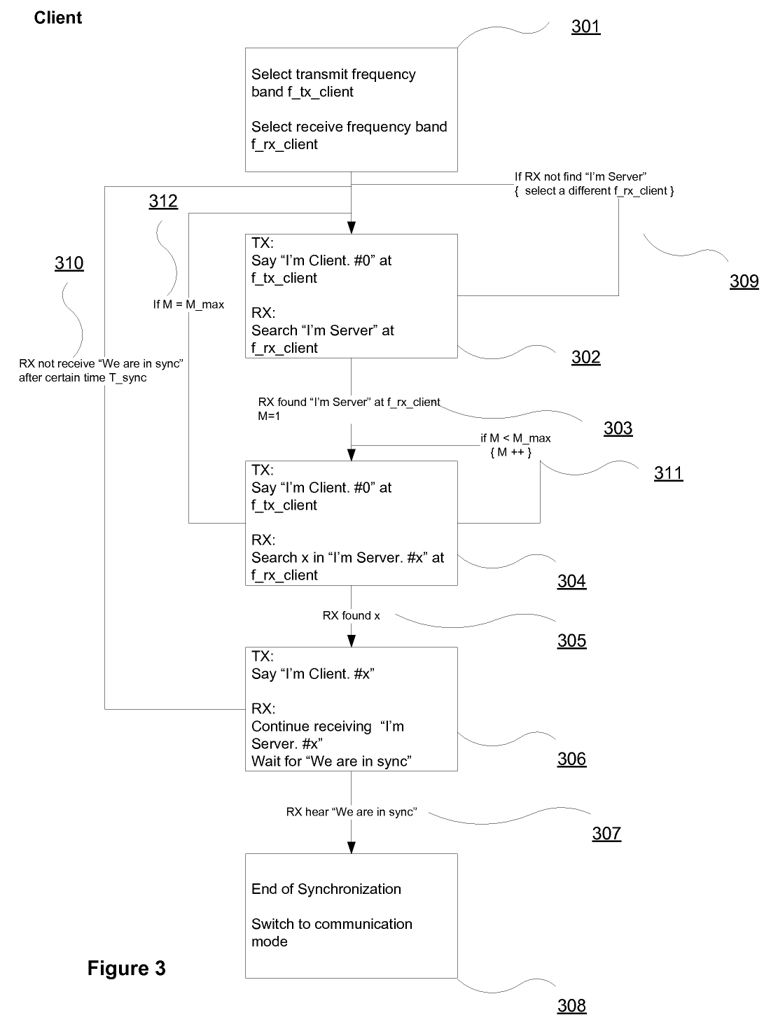

FIG. 3 shows the flow chart on how the client establishes the link. Same as the server, the client has to go through the process of DAA to figure out which frequency it can transmit. At step 301, the transmit frequency f_tx_client is selected by DAA. A receive frequency f_rx_client is selected arbitrarily.

In one embodiment, at step 302, transmitter send a binary data string representing the message of “I'm Client. #0”. The receiver searches “I'm Server” at f_rx_client. If the receiver cannot find it, it continues back to 302 as shown in condition 309.

Once the receiver finds “I'm Server” at f_rx_client as shown in condition 303, the transmitter says “I'm Client #0” at f_tx_client, and the receiver searches x in “I'm Server. #x” at f_rx_client as shown in step 304. Note that the f_rx_client is the same as f_tx_server, which is called the downlink frequency. A counter M is maintained to count how many times the Client has searched for x. If it is below M_max as shown in 311, it keeps searching. However, if M exceeds M_max as shown in 312, the protocol moves back step 302.

When x is found in condition 305, the protocol moves to step 306, where the receiver waits for “We are in sync” from the server. If the client does not receive “We are in Sync” after T_sync period as shown in 310, the protocol moves back to step 302.

When “We are in sync” is received in 307, the protocol moves to step 308 showing the end of synchronization. The Client can move to communication mode.

2. Repeater

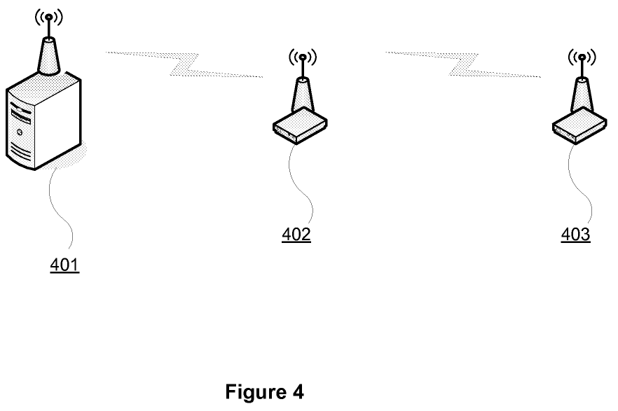

In FIG. 4, the network consists of a server 401, a client 403 and an additional repeater 402. The same protocol can be shown in the previous section can be applied between the server 401 and the repeater 402, and between the repeater 402 and the client 403.

3. Concurrent Control of Rendering Device

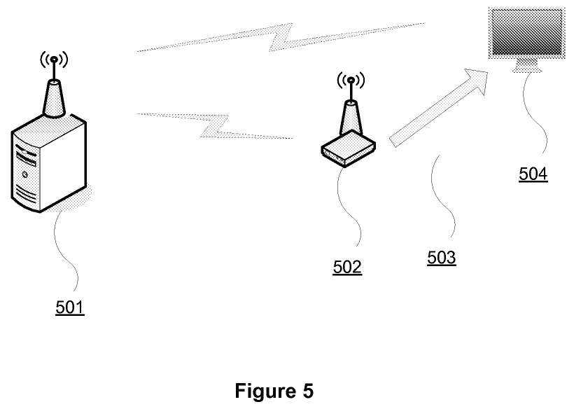

One of the applications of this network is to transmit TV signals from the server 501 to a TV 504 as shown in FIG. 5, where the TV 504 is controlled by the Client 502 via certain interface 503, say infrared. When the server 501 and the client 502 are switched to the communication mode, the server 501 starts transmitting video signals at the downlink frequency, i.e. f_tx_server or f_rx_client. The Client 502 can then automatically switch the TV 504 to the downlink frequency without user's intervention via the interface 503.

What is claimed is:

1. A wireless communication network comprising:
an broadcasting protocol;
a server;
a client; and
a repeater.

2. A method for the server to synchronize with the client using any existing broadcasting protocol

3. A method for the client to synchronize with the server using any existing broadcasting protocol

4. A method for the repeater to synchronize with the server using any existing broadcasting protocol

5. A method for the device to concurrently control the rendering device based on the synchronization result
